(19) United States
(12) Patent Application Publication
(10) Pub. No.: US 2026/0162402 A1
(43) Pub. Date: Jun. 11, 2026

(54) SIMILARITY-BASED WAFER FAILURE PATTERN ANALYSIS METHOD AND APPARATUS USING IMAGE MATCHING

(71) Applicants: SK hynix Inc., Icheon-si (KR); Industry-Academic Cooperation Foundation, Dankook University, Yongin-si (KR)

(72) Inventors: Seokchan HONG, Icheon-si (KR); Seung Taek Lee, Icheon-si (KR); Woosik Jung, Icheon-si (KR); Hyun Jin Kim, Yongin-si (KR); Young Wook Kwon, Yongin-si (KR); Soo Min Oh, Gyeonggi-do (KR)

(21) Appl. No.: 19/183,613

(22) Filed: Apr. 18, 2025

(30) Foreign Application Priority Data
Apr. 18, 2024 (KR) 10-2024-0052103

(51) Int. Cl. G06V 10/74; G06T 7/00; G06V 10/25; G06V 10/46; G06V 10/75; G06V 10/84

(52) U.S. Cl. CPC G06V 10/761; G06T 7/001; G06V 10/25; G06V 10/46; G06V 10/751; G06V 10/84; G06T 2207/20084; G06T 2207/30148

(57) ABSTRACT

Similarity-based wafer failure pattern analysis may include optionally performing preprocessing to establish a region of interest determined to be a failure pattern region in a first wafer image corresponding to a wafer bin map (WBM), obtaining a plurality of keypoints and a plurality of descriptors associated therewith from the first wafer image, performing image matching between the first wafer image and a second wafer image corresponding to the WBM, and numerically evaluating the image similarity between the first and second wafer images. In the absence of the preprocessing, the image similarity may be numerically evaluated according to the first algorithm using a normalized score representing the similarity between the keypoints. If the preprocessing has been performed, the image similarity may be numerically evaluated according to a second method reflecting information of a first and second regions of interest respectively obtained from the first and second wafer images.

### CROSS-REFERENCE TO RELATED APPLICATION

The present application claims, under 35 U.S.C. § 119 (a), the benefit of Korean Patent Application No. 10-2024-0052103, filed on Apr. 18, 2024, which is herein incorporated by reference in its entirety.

### BACKGROUND

### 1. Field

Embodiments of the present disclosure relates to semiconductor processes and related methods and apparatus, and more particularly to methods and apparatus for analyzing wafer failure patterns.

### 2. Description of the Related Art

Semiconductor devices can be produced on a wafer basis, and after all processes are completed on a wafer basis, the chips in the wafer are cut/separated to become semiconductor chips. A wafer bin map (WBM) is a two-dimensional image that illustrates the results of pass/fail determination for each chip in a wafer. In the semiconductor post-processing, electrical die sorting (EDS) test is a process that checks whether each chip on the wafer has reached the desired quality level through electrical characterization testing. After EDS testing, a WBM is obtained, which is a two-dimensional image of each chip that indicates whether that chip has passed or failed. By analyzing the patterns on the WBM, the cause of the failure can be identified and the yield can be increased. Since wafers fabricated in the same process and equipment are likely to have similar failure patterns (i.e., defect patterns), it is necessary to analyze and classify the failure patterns. This can help identify the process that wafers with similar failure patterns have gone through, identify and improve the problems in that process, and contribute to increasing yield. When an abnormality occurs in a particular process and facility, wafers that have gone through that process and equipment may exhibit similar WBM failure patterns. For example, an edge-ring failure pattern can be mainly caused by an uneven plasma etching speed. For a scratch failure pattern, it can be mainly caused by wafer handling issues during the chemical mechanical polishing (CMP) process or during transportation. Therefore, by categorizing WBM failure patterns, the specific process and equipment that caused the failure can be quickly traced based on the classification results to quickly resolve the root cause.

To classify wafer failure patterns, in the past, people used to classify fail patterns by visual inspection or make decisions through rule-based programming based on failure data. However, there are issues with uneven accuracy due to human error and the high demand for human resources. Therefore, an efficient and highly accurate deep learning-based automation of fault pattern recognition and classification was required.

Recent research for automated wafer failure pattern classification includes supervised learning based classification methods using convolutional neural networks (CNNs). However, the supervised learning-based methods require labeling image data for learning of deep learning models. Creating this labeled data takes a lot of manpower and time, and also has a high probability of being inaccurate. In addition, the entire model needs to be retrained every time a new failure pattern is added, which can be very inefficient in terms of time and cost. To compensate for this, research has been conducted using an unsupervised learning-based clustering method, but even though it goes through a cumbersome process of defining the number of clusters or establishing a probability distribution model, the performance is generally poor. In addition, as semiconductor processes become more complex, the classification-based method has the disadvantage of being insufficient to reveal (i.e. represent) the causes of complex failure patterns.

### SUMMARY

The technological object to be achieved by embodiments of the present disclosure is to provide a method and apparatus for similarity-based wafer failure pattern analysis using image matching that may effectively analyze wafer failure patterns by numerically evaluating the image similarity between a source wafer image, whose failure pattern is to be analyzed, and a target wafer image(s) to which the failure pattern is to be compared.

In addition, the technological object to be achieved by embodiments of the present disclosure is to provide a method and apparatus for analyzing wafer failure patterns based on similarity using image matching, which does not require labeled data (i.e., labeled WBM data) for learning and is useful for efficiently analyzing the causes of single/complex failure patterns by using a method for numerically evaluating/analyzing image similarity according to a predetermined method rather than a conventional classification method.

In addition, the technological object to be achieved by embodiments of the present disclosure is to provide a method and apparatus for similarity-based wafer failure pattern analysis using image matching that may improve the accuracy and efficiency of wafer failure pattern analysis and failure cause analysis.

The objects to be achieved by embodiments of the present disclosure are not limited to the objects mentioned above, and other objects not mentioned will be understood by those skilled in the art from the description below.

According to one embodiment of the present disclosure, a method of analyzing wafer failure patterns based on similarity comprises obtaining a plurality of keypoints and a plurality of descriptors associated therewith from a first wafer image; performing image matching between the first wafer image and a second wafer image corresponding to a Wafer Bin Map (WBM), wherein there are a plurality of keypoints obtained from the second wafer image and a plurality of descriptors associated therewith, and wherein the image matching is performed in a keypoint matching process based on descriptor comparison; and numerically evaluating an image similarity between the first and the second wafer images.

The numerically evaluating image similarity between the first and the second wafer images comprises numerically evaluating the image similarity according to a first algorithm using a normalized score that normalizes a matching score or normalizes a square of the matching score, the matching score being representative of the similarity between keypoints.

The first algorithm may comprise: deriving a plurality of confidence values by assigning different weights to the plurality of the matching scores based on a range of magnitudes of the plurality of the normalized scores obtained for the plurality of keypoints matched between the first and the second wafer images; and deriving a confidence score by dividing a sum of the plurality of confidence values by a number of the matched plurality of keypoints.

The first algorithm may include deriving a plurality of confidence values normalized by the squared values of the plurality of the matching scores obtained for the plurality of features matched between the first and the second wafer images; and deriving a confidence score by dividing a sum of the plurality of confidence values by a number of the matched plurality of keypoints.

The method further comprises performing pre-processing to establish first and second regions of interest that are determined to be failure pattern regions in the first wafer image corresponding to the WBM, wherein numerically evaluating image similarity between the first and the second wafer images comprises numerically evaluating the image similarity according to a second algorithm that reflects information of a first region of interest obtained from the first wafer image and information of a second region of interest obtained from the second wafer image.

The second algorithm may utilize at least one of size and location information of the first region of interest and at least one of size and location information of the second region of interest.

The second algorithm may include: deriving the size of the first region of interest; deriving the size of the second region of interest; and comparing the sizes of the first and the second regions of interest to derive a first penalty value associated with the size of the region of interest.

The first penalty value may be defined by the following mathematical formula

$${P}_{Size} = \{ \begin{matrix}\frac{{Size}_{target}}{{Size}_{source}} & if {Size}_{source} \geq {Size}_{target} \\ \frac{{Size}_{source}}{{Size}_{target}} & if {Size}_{source} < {Size}_{target} \\ 0 & Otherwise\end{matrix} \qquad [ math expression ]$$

wherein the P_{Size} represents the first penalty value, said Size_{source} represents the size of the first region of interest, and the Size_{target} represents the size of the second region of interest.

The second algorithm may include: deriving the location information of the first region of interest; deriving location information of the second region of interest; and comparing location information of the first and the second regions of interest to derive a second penalty value associated with the location of the region of interest.

The second penalty value may be defined by the following mathematical formula

$${P}_{Location} = \frac{{Region}_{source ⋂ target}}{{Region}_{source}} \qquad [ math expression ]$$

wherein the P_{Location} represents the second penalty value, the Region_{source} represents the number of pixel regions corresponding to the first region of interest, and the Region_{source∩target} represents the number of pixel regions in which the first and the second regions of interest exist together.

The second algorithm comprises: deriving the size of the first region of interest; deriving the size of the second region of interest; comparing the sizes of the first and the second regions of interest to derive a first penalty value associated with the size of the region of interest; deriving the location information of the first region of interest; deriving the location information of the second region of interest; and comparing the location information of the first and second regions of interest to derive a second penalty value associated with the location of the region of interest; and deriving a region of interest matching score derived for a plurality of features matched between the first and second regions of interest by multiplying the first penalty value and the second penalty value to derive a match of defect (MoD) score.

The second wafer image may be an image included in a wafer image database that includes one or more wafer images corresponding to the WBM.

The second wafer image may be an unprocessed image.

The second wafer image may be a preprocessed image.

The image matching may be performed using a graph neural network (GNN) model.

The image matching may be performed using a matching algorithm based on graph attention networks (GATs).

The image matching may be performed using any of a variety of feature point matching algorithms.

According to another embodiment of the present disclosure, performing pre-processing to establish a region of interest determined to be a failure pattern region in a first wafer image corresponding to a wafer bin map (WBM); obtaining a plurality of keypoints and a plurality of descriptors associated therewith from the first wafer image; performing image matching between the first wafer image and a second wafer image corresponding to the WBM, wherein there are a plurality of keypoints obtained from the second wafer image and a plurality of descriptors associated therewith, and wherein the image matching is performed in a keypoint matching method based on descriptor comparison; and numerically evaluating an image similarity between the first and the second wafer images, using information of a first region of interest obtained from the first wafer image and information of a second region of interest obtained from the second wafer image.

According to another embodiment of the present disclosure, an apparatus comprising a processor and a memory, the memory storing one or more instructions, and the processor executing the one or more instructions, obtaining a plurality of keypoints and a plurality of descriptors associated therewith from the first wafer image, optionally performing image matching between the first wafer image and a second wafer image corresponding to a Wafer Bin Map (WBM), wherein there are a plurality of keypoints obtained from the second wafer image and a plurality of descriptors associated wherewith, and wherein the image matching is performed in a keypoint matching method based on descriptor comparison, and numerically evaluating the image similarity between the first and second wafer images.

The numerically evaluating the image similarity between the first and the second wafer image comprises numerically evaluating the image similarity according to a first algorithm using a normalized score that normalizes a matching score or that normalizes a square of the matching score, the matching score being representative of the similarity between the keypoints.

The similarity-based wafer failure pattern analysis apparatus further comprises performing pre-processing to establish regions of interest that are determined to be failure pattern regions in a first wafer image corresponding to the WBM, and wherein numerically evaluating image similarity between the first and the second wafer images comprises numerically evaluating the image similarity according to a second algorithm reflecting information of a first region of interest obtained from the first wafer image and information of a second region of interest obtained from the second wafer image.

According to embodiments of the present disclosure, a similarity-based wafer failure pattern analysis method and apparatus using image matching may be implemented to effectively analyze wafer failure patterns by numerically evaluating image similarity between a source wafer image, which is the target for failure pattern analysis, and a target wafer image(s) to be compared.

Further, according to embodiments of the present disclosure, by using a method of numerically evaluating/analyzing image similarity according to a predetermined method rather than a conventional classification method, a similarity-based wafer failure pattern analysis method and apparatus using image matching that does not require labeled data (i.e., labeled WBM data) for training and is useful for efficiently analyzing the causes of single/complex failure patterns may be implemented.

Furthermore, embodiments of the present disclosure enable a similarity-based wafer failure pattern analysis method and apparatus using image matching to enable efficient analysis, as the target wafer image may be searched for any of the desired information of the shape (appearance), location, and size of the failure pattern.

In addition, embodiments of the present disclosure may implement a similarity-based wafer failure pattern analysis method and apparatus using image matching that may increase the accuracy and efficiency of wafer failure pattern analysis and failure cause analysis.

Methods and apparatus for similarity-based wafer failure pattern analysis using image matching, according to embodiments, may enable faster and more accurate identification of problem sources in a semiconductor process, process optimization, and increased yields in a semiconductor process.

However, the effects of the present invention are not limited to the above effects, and may be extended in various ways without departing from the technical ideas and scope of the present invention.

### BRIEF DESCRIPTION OF THE DRAWINGS

FIG. 1 illustrates a process for similarity-based wafer failure pattern analysis using image matching, according to one embodiment of the present disclosure.

FIG. 2 illustrates a process for similarity-based wafer failure pattern analysis using image matching, according to one embodiment of the present disclosure.

FIG. 3 is an example illustrating an image matching process that may be applied to a wafer failure pattern analysis process according to one embodiment of the present disclosure.

FIG. 4 illustrates a process for keypoint extraction and descriptor generation that may be applied to a wafer failure pattern analysis process according to one embodiment of the present disclosure.

FIG. 5 illustrates a process for evaluating similarity using Mscore and its challenges, according to an illustrative example.

FIG. 6 is an example illustrating a pre-processing and applied image matching process that may be applied to a wafer failure pattern analysis process according to one embodiment of the present disclosure.

FIG. 7 is an example illustrating a process for deriving size information of a region of interest that may be applied to a wafer failure pattern analysis process according to one embodiment of the present disclosure.

FIG. 8 is an example illustrating a process for deriving location information of a region of interest that may be applied to a wafer failure pattern analysis process according to one embodiment of the present disclosure.

FIG. 9 is a visualized flow diagram of an illustrative process for similarity-based wafer failure pattern analysis using image matching, according to one embodiment of the present disclosure.

FIG. 10 is a visualized flow diagram of an illustrative process for similarity-based wafer failure pattern analysis using image matching, according to another embodiment of the present disclosure.

FIG. 11 is a block diagram to illustrate a similarity-based wafer failure pattern analysis apparatus using image matching, according to one embodiment of the present invention.

FIG. 12 illustrates an example of the results of performing a failure pattern analysis using a wafer failure pattern analysis process according to an embodiment of the present disclosure.

FIG. 13 illustrates an example of the results of performing a failure pattern analysis using a wafer failure pattern analysis process according to an embodiment of the present disclosure.

FIG. 14 illustrates an example of the results of performing a failure pattern analysis using a wafer failure pattern analysis process according to an embodiment of the present disclosure.

FIG. 15 illustrates an example of the results of performing a failure pattern analysis using a wafer failure pattern analysis process according to an embodiment of the present disclosure.

### DETAILED DESCRIPTION

Hereinafter, the embodiments of the present disclosure will be described in detail with reference to the accompanying drawings.

The embodiments of the present disclosure to be described below are provided to more clearly explain some of various embodiments of the present disclosure to those having ordinary skill in the art, and the scope of embodiments of the present disclosure not limited by the following embodiments, and the embodiments may be modified in many different forms.

The terms indicating a singular form used herein may include plural forms unless the context clearly indicates otherwise. Also, as used herein, the terms, “comprise” and/or “comprising” specify the presence of the stated shape, step, number, operation, member, element, and/or group thereof and does not exclude the presence or addition of one or more other shapes, steps, numbers, operations, elements, elements and/or groups thereof. In addition, the term, “connection” used in this specification means not only a direct connection of certain members, but also an indirect connection in which other members are interposed between the members.

In addition, designations such as “first” and “second,” “upper or top,” and “lower or bottom” in the description herein are intended to distinguish members and are not intended to define the members themselves or to imply a particular order, but rather to indicate a relative positional relationship and not to limit the specific instances in which other members may be introduced into direct contact with or at the interface between the members. The same interpretation may be applied to other expressions describing relationships between components.

In addition, in the present specification, when a member is said to be located “on” another member, this arrangement includes not only a case in which a member is in contact with another member, but also a case where another member exists between the two members. As used herein, the term, “and/or” includes any one and all combinations of one or more of the listed items. In addition, the terms of degree such as “about” and “substantially” used in the present specification are used as a range of values or degrees, or as a meaning close thereto, taking into account inherent manufacturing and substance tolerances, and exact or absolute numbers provided to aid in the understanding of this application are used to prevent the infringers from unfairly exploiting the stated disclosure.

Hereinafter, embodiments of the present disclosure will now be described in detail with reference to the accompanying drawings. A size or a thickness of areas or parts shown in the accompanying drawings may be exaggerated for clarity of the description and convenience of description. Throughout the detailed description, the same reference numbers indicate the same configuring elements.

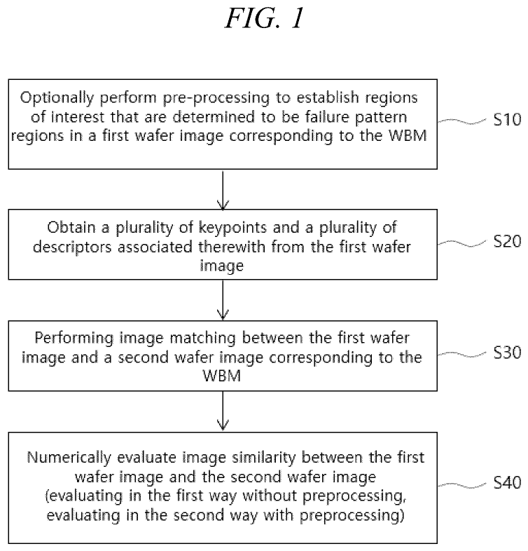

FIG. 1 is a flowchart illustrating a process for similarity-based wafer failure pattern analysis using image matching, according to one embodiment of the present invention.

Referring to FIG. 1, a process for analyzing a similarity-based wafer failure pattern (failure pattern) using image matching according to an embodiment of the present disclosure comprises: optionally performing a step (S10) of pre-processing a first wafer image corresponding to a wafer bin map (WBM) to establish a region of interest determined to be a failure pattern region, acquiring a plurality of keypoints and a plurality of descriptors associated therewith from the first wafer image (S20), performing image matching between the first wafer image and a second wafer image corresponding to the WBM (S30), and numerically evaluating image similarity between the first and second wafer images (S40). There may be a plurality of keypoints obtained from the second wafer image and a plurality of descriptors associated therewith, and step S30 may be performed by keypoint matching based on descriptor comparison. In the S40 stage, if the above pre-processing is not performed, the image similarity may be numerically evaluated according to a first algorithm using a normalized matching score or a normalized score that is the square of the normalized matching score. After performing the pre-processing, the image similarity may be evaluated numerically according to a second algorithm that reflects the information of the first region of interest obtained from the first wafer image and the information of the second region of interest obtained from the second wafer image. Here, the first region of interest may be the region set by the preprocessing, and the second region of interest may be the region set by the preprocessing process corresponding to the preprocessing.

The wafer bin map (WBM) may be a two-dimensional image representation of the pass/fail results for each chip (i.e., die) in the wafer. When an abnormality occurs in a particular process and facility, wafers that have gone through that process or facility may exhibit a similar WBM failure pattern. The failure pattern (defect pattern) may include, as a non-limiting example, a center failure pattern, a donut failure pattern, a loc failure pattern, an edge-loc failure pattern, an edge-ring failure pattern, a scratch failure pattern, a near-full failure pattern, a random failure pattern, a cluster failure pattern, and the like. By analyzing wafer failure patterns and quickly determining the specific process and facility that caused the failure based on the analysis results, the root cause may be quickly resolved.

In step S10, preprocessing may optionally be performed to establish an area of interest determined to be a failure pattern area in the first wafer image. The first wafer image may be a source WBM image. The preprocessing may be performed using an object detector. The object detector may be a type of trained learning model. For the first wafer image, the area determined to be a failure pattern area may be set as a region of interest using the pre-trained object detector. At this time, the remaining chip (i.e., die) areas except the region of interest may be set as an irrelevant area or deleted. By setting the region of interest through the pre-processing and using it in subsequent processes, the performance of wafer failure pattern analysis may be improved.

At step S10, if necessary, preprocessing may be performed on the second wafer image. In other words, in step S10, preprocessing may optionally be performed to establish regions of interest determined to be failure pattern regions in the second wafer image. The second wafer image may be a target WBM image to which the first wafer image is to be compared. The second wafer image may be, for example, an image included in a wafer image database (DB). The wafer image database may include one or more wafer images corresponding to the WBM. The wafer image database may include a plurality of wafer images, and at least some or all of the plurality of wafer images may be the object of comparison, i.e., the target WBM image. As a non-limiting example, a process of analyzing a wafer failure pattern according to embodiments of the present disclosure may be or include searching for (detecting) a WBM image (stored in a database) having a failure pattern similar to a source WBM image (i.e., an input WBM image).

According to one embodiment, the second wafer image may be an unprocessed image or a pre-processed image. In other words, the second wafer image may be stored in the database in an unprocessed state, or may be stored in the database in a pre-processed state. If the second wafer image is preprocessed and stored in the database, no further preprocessing may be performed on the second wafer image in step S10. On the other hand, if the second wafer image is stored in the database in an unprocessed state, preprocessing may be performed on the second wafer image in step S10, if necessary.

At step S20, a plurality of keypoints may be extracted from the first wafer image. The keypoints may be referred to as image keypoints, meaning points in the image that are characterized by a given image. An image keypoint may also be referred to as a keypoint or as a feature point. The keypoints may be a point in the image where a brightness difference between region(s) occurs, a color difference occurs, a point where the image changes rapidly, a vertex, an edge, a corner, a boundary, etc. The keypoints may be extracted by a keypoint extraction algorithm. The keypoint extraction algorithm may also be referred to as a detector, e.g., a keypoint detector. The first wafer image may be divided into a plurality of pixel regions, and the plurality of keypoints may be extracted from the plurality of pixel regions. When the first wafer image is input, image-related maxima, minima, and the like in the pixel regions may be calculated, and keypoints representing characteristics of the image may be extracted through the keypoint extraction algorithm.

At step S20, a plurality of descriptors may be generated, wherein the plurality of keypoints of the first wafer image are given directional information. The descriptors may be feature vectors describing the image as image descriptors. The descriptor may be obtained by giving directional information to the keypoints via differentiation. Alternatively, the descriptor may be obtained by computing the relationship of each keypoints to its neighboring pixels to generate a feature vector. The descriptor may be generated by assigning an N-dimensional vector of orientation information to the neighborhood of the pixel where the feature is located via a descriptor algorithm. The descriptor algorithm may calculate the magnitude and directional changes to the values of the neighboring pixels of the extracted keypoint to generate a descriptor that refines the keypoint information. In some cases, the descriptor algorithm may be referred to as a descriptor.

At step S20, if desired, a plurality of keypoints may be extracted from the second wafer image, and a plurality of descriptors for the plurality of keypoints of the second wafer image may be generated.

When image matching is performed based on the above-mentioned keypoints, image matching may not be easy when the image is rotated, tilted, or skewed due to indiscriminate features. However, when image matching is performed based on descriptors that have directional information assigned to the above keypoints, all directional information is retained even when the image is rotated, tilted, or skewed, so that robust characteristics may be secured against image rotation or tilt, and image matching may be performed more easily and accurately. The descriptors described above may also be referred to as “oriented features”.

In step S30, image matching between the first and the second wafer images may be performed. The image matching may be performed in a keypoint matching manner based on descriptor comparison. By comparing a plurality of descriptors of the first wafer image with a plurality of descriptors of the second wafer image, image matching between the first and the second wafer images may be performed. In other words, by comparing a plurality of descriptor-assigned features of the first wafer image with a plurality of descriptor-assigned features of the second wafer image, the image matching may be performed. The image matching may be performed using a matching algorithm. By the matching algorithm, keypoint information extracted from the first and the second wafer images may be matched between keypoints that are determined to be similar. The matching algorithm may be referred to as a matcher.

According to one embodiment, at or after step S30, a matching score, which is an indicator of similarity between the features, may be calculated. For example, a matching score may be calculated that quantifies the similarity via distance information between descriptors. The matching score may be, for example, a Mscore. The Mscore will be described in more detail later.

In step S30, the image matching may be performed using a learning model trained by unsupervised learning without using labeled data. In other words, the image matching may be performed using a learning model trained using an unsupervised learning process without using labeled data and without performing supervised learning to match the correct answer. Existing supervised learning-based techniques require labeling of image data to correspond to correct answers in order to train a deep learning model, and the creation of labeled data is not only labor- and time-consuming, but also likely to be inaccurate. In addition, the entire model must be retrained every time a new failure pattern is added, which may be very inefficient in terms of time and cost. However, according to an embodiment of the present disclosure, wafer failure patterns may be analyzed by performing image matching through a learning model trained by unsupervised learning without the use of labeled data.

In embodiments of the present disclosure, a matching algorithm may be used to measure similarity by comparing descriptors generated from each wafer image, i.e., descriptors for orientation-informed features. Since high similarity features should be matched, for example, a distance-based similarity measure between descriptors may be used. Unlike traditional methods (classification using CNNs), this approach may not require labeled training data because image matching is based on the similarity of the images.

In step S40, the image similarity between the first and the second wafer images may be numerically evaluated. In the absence of the preprocessing, the image similarity may be numerically evaluated according to the first algorithm using a normalized score, wherein a matching score representing the similarity between the keypoints is normalized or a normalized value of the square of the matching score is normalized. If the preprocessing has been performed, the image similarity may be numerically evaluated according to a second algorithm using information of a first region of interest obtained from the first wafer image and information of a second region of interest obtained from the second wafer image. By utilizing the above first algorithm and the above second algorithm, the accuracy and efficiency of wafer failure pattern analysis may be greatly improved. Specific examples of the first algorithm and specific examples of the second algorithm will be described in detail hereinafter.

According to one embodiment, extracting the plurality of keypoints and generating the plurality of descriptors may be performed in a mathematical computational manner without using a deep learning model. As a non-limiting example, extracting the plurality of keypoints and generating the plurality of descriptors may be performed using any one of the following algorithms: oriented fast and rotated BRIEF (ORB), scale-invariant feature transform (SIFT), and speeded up robust features (SURF). For example, in the case of the SIFT algorithm above, an image with edges extracted from the image may be obtained, and then the image-related maxima and minima around a single pixel may be found to be candidate keypoints. Then, to extract sharper and more accurate keypoints, a Hessian matrix may be applied to these keypoint candidates to extract what is determined to be a corner as the final keypoint. Algorithms such as ORB, SIFT, SURF, and the like may perform keypoint extraction and descriptor generation by computing on the information around the pixel without using a deep learning model, thus reducing the consumption of computing resources. However, the process of extracting the plurality of keypoints and generating the plurality of descriptors without using a deep learning model is not limited to the ORB, SIFT, and SURF algorithms, and other algorithms may be applied. For example, a Harris corner detector may be used to extract the plurality of keypoints and generate the plurality of descriptors.

In one embodiment, the plurality of keypoint extraction and the plurality of descriptor generation may be performed using a deep learning model. In this case, as a non-limiting example, the extraction of the plurality of keypoints and the generation of the plurality of descriptors may be performed using one of the following algorithms: learned invariant feature transform (LIFT) and self-supervised interest point detection and description (SuperPoint). Algorithms such as LIFT and SuperPoint may generate keypoints and descriptors by training a deep learning model, and such algorithms may extract/generate keypoints and descriptors with high accuracy. However, the process of extracting the plurality of keypoints and generating the plurality of descriptors using the above deep learning model is not limited to the LIFT and SuperPoint algorithms, and other algorithms may be applied.

In one embodiment, the image matching may be performed using a graph neural network (GNN) model. The similarity of descriptors generated for the wafer images may be determined using a trained GNN-type model. The image matching may also be performed using a matching algorithm based on graph attention networks (GATs). A graph neural network (GNN) that represents the mutual positional relationship between features (directionally informed features) and an attention mechanism that emphasizes important features (directionally informed features) may be applied to matching wafer failure image patterns, and similar features (directionally informed features) in the images to be compared may be linked by a matching algorithm.

In one specific example, the image matching may be performed using a SuperGlue algorithm. The SuperGlue algorithm may be a matching algorithm based on GNNs and GATs. The SuperGlue algorithm may comprise nodes in the matching between descriptors previously generated for the images, wherein the nodes represent connections between descriptors that have the potential to be connected, and the GATs may then predict the likelihood of matching between images through an attention mechanism. By utilizing a matching algorithm based on GATs, such as SuperGlue, it may be possible to more easily understand the relationship of wafer failure patterns and thus match with higher accuracy. However, various other algorithms other than the SuperGlue algorithm may be applied to image matching according to embodiments of the present disclosure.

According to one embodiment, the image matching may be performed based on a degree of proximity of the descriptors generated for the wafer images. The proximity of the descriptors may correspond to, as a non-limiting example, a Euclidean distance, a Manhattan distance, a Hamming distance, or the like. Through such proximity-based image matching, the similarity of images (data) may be measured.

In extracting the plurality of keypoints, generating the plurality of descriptors, and matching the images, various algorithms may be used, and appropriate algorithms may be selected or combined as needed to apply to wafer failure pattern analysis.

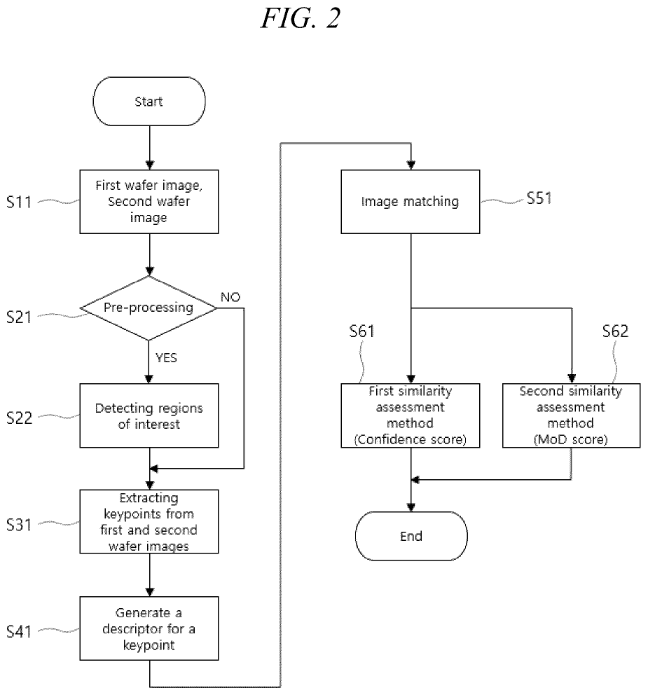

FIG. 2 is a flowchart to illustrate a process of similarity-based wafer failure pattern analysis using image matching, according to one embodiment of the present disclosure.

Referring to FIG. 2, a process for analyzing a similarity-based wafer failure pattern using image matching according to an embodiment of the present disclosure may include a step S11 of inputting a first wafer image corresponding to a source WBM image. The first wafer image may be input to a processor of an analysis device. A second wafer image corresponding to the target WBM image may be an image stored in a database. The second wafer image may be input to a processor of the analysis device.

The process of analyzing a wafer failure pattern may include optionally performing a step (S21) of pre-processing the first wafer image to establish a region of interest determined to be a failure pattern region. Step S21 may correspond to step S10 described in FIG. 1.

According to one embodiment, the second wafer image may be an unprocessed image or a preprocessed image. For example, the second wafer image may be stored in the database in an unprocessed state, or may be stored in the database in a preprocessed state. If the second wafer image is preprocessed and stored in the database, no further preprocessing may be performed on the second wafer image in step S21. In this case, the second wafer image may be treated as preprocessed, if desired. On the other hand, if the second wafer image is stored in the database in an unprocessed state, preprocessing may be performed on the second wafer image in step S21, if necessary.

As a result of step S21, region of interest detection may be performed (step S22). In step S22, a first region of interest determined to be a failure pattern region in the first wafer image may be set. Further, a second region of interest determined to be a failure pattern region in the second wafer image may be set. The region of interest detection may be referred to as failure pattern region detection. In some embodiments step S22 may be considered to be included in step S21.

The process of analyzing a wafer failure pattern may include a step (S31) of extracting a plurality of keypoints from each of the first and the second wafer images, and a step (S41) of generating a plurality of descriptors for the plurality of keypoints extracted from each of the first and the second wafer images. Steps S31 and S41 may correspond to or be similar to step S20 described in FIG. 1.

The process of analyzing wafer failure patterns may comprise the step (S51) of performing image matching between the first and the second wafer images. The image matching may be performed in a keypoint matching manner based on descriptor comparison. Step S51 may correspond to step S30 described in FIG. 1.

The process of analyzing wafer failure patterns may comprise the step of numerically evaluating image similarity between the first and the second wafer images (S61, S62). Depending on whether or not the preprocessing has been performed, the manner in which the image similarity is evaluated may vary. In the absence of the preprocessing, the image similarity may be numerically evaluated according to a first algorithm using a normalized score that normalizes the matching score representing the similarity between the keypoints or a normalized score that normalizes the squared value thereof (step S61). If the preprocessing has been performed, the image similarity may be numerically evaluated according to a second algorithm using information of a first region of interest obtained from the first wafer image and information of a second region of interest obtained from the second wafer image (step S62). Steps S61 and S62 may correspond to step S40 described in FIG. 1.

If no pre-processing is used, the image similarity may be numerically evaluated according to a first algorithm using a normalized score, which normalizes the matching score or normalizes the squared value of the matching score, thereby reducing the influence of outlier regions, i.e. regions other than the fault pattern region. The first algorithm may use a confidence score, to be defined hereinafter.

The matching score may be a Mscore. A normalized score may be derived by normalizing the plurality of Mscores to a value between 0 and 1. In other words, the plurality of Mscores may be normalized by setting the minimum Mscore to 0 and the maximum Mscore to 1. Alternatively, the plurality of Mscores², which are the squared values of the plurality of Mscores, may be normalized between 0 and 1 to derive a normalized score, i.e., the plurality of Mscores² may be normalized by setting the minimum Mscore² to 0 and the maximum Mscore² to 1.

According to one example, a plurality of confidence values may be derived by assigning different weights to the plurality of the matching scores (e.g., Mscores) according to a range of magnitudes of the plurality of the normalized scores obtained for the plurality of features matched between the first and the second wafer images, and a confidence score may be derived by dividing the sum of the plurality of confidence values by the number of the plurality of matched features. In another example, a plurality of confidence values normalized by the squared values of a plurality of the matching scores (e.g., Mscore) obtained for the plurality of features matched between the first and the second wafer images may be derived, and the sum of the plurality of confidence values may be divided by the number of the matched plurality of features to derive a confidence score. By utilizing the confidence score as described above, the influence of the outlier region may be reduced, and an accurate similarity calculation considering the shape of the failure pattern of the first and the second wafer images may be performed.

If pre-processing is utilized, the image similarity may be numerically evaluated according to a second algorithm that takes into account information of a first region of interest obtained from the first wafer image and information of a second region of interest obtained from the second wafer image, thereby increasing the accuracy of the similarity calculation. The second algorithm may calculate the similarity using a match of defect (MoD) score, to be defined hereinafter.

The second algorithm may evaluate the similarity between the first wafer image (source WBM) and the second wafer image (target WBM) using at least one of the size and location information of the first region of interest obtained through preprocessing and at least one of the size and location information of the second region of interest obtained through preprocessing. Using the second algorithm, the similarity calculation may take into account not only the shape (appearance) of the failure pattern in the two wafer images, but also the size and location of the failure pattern.

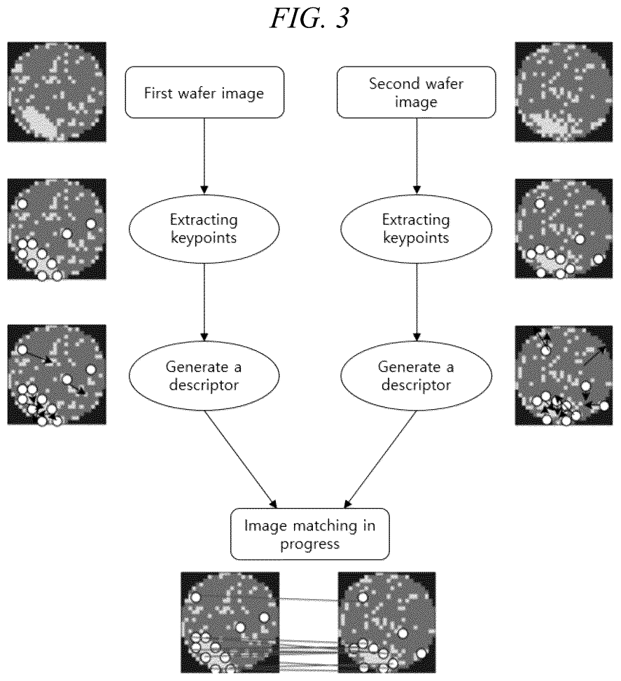

FIG. 3 is a conceptual diagram illustrating an image matching process that may be applied to a wafer failure pattern analysis process according to one embodiment of the present disclosure.

Referring to FIG. 3, a similarity-based wafer failure pattern analysis process using image matching according to an embodiment of the present disclosure may include the steps of extracting a plurality of keypoints from a first wafer image corresponding to a WBM and generating a plurality of descriptors for the plurality of keypoints of the first wafer image. Further, the wafer failure pattern analysis process may include the steps of extracting a plurality of keypoints from a second wafer image corresponding to the WBM and generating a plurality of descriptors for the plurality of keypoints of the second wafer image. The first wafer image may be a source WBM image, and the second wafer image may be a target WBM image. The first wafer image may be an image of a wafer to be analyzed for wafer failure patterns. The second wafer image may be any one of a plurality of wafer images included in a wafer image database.

The wafer failure pattern classification process may include the step of performing image matching between the first wafer image and the second wafer image by comparing a plurality of descriptors of the first wafer image with a plurality of descriptors of the second wafer image. The image matching may be performed via a learning model trained in an unsupervised learning manner without the use of labeled data.

The first wafer image may be input to a predetermined computer device, and keypoint extraction and descriptor generation for the first wafer image may be performed by the computer device. The computer device may store the second wafer image and corresponding keypoint and descriptor information. Alternatively, the second wafer image may be input to the computer device, and keypoint extraction and descriptor generation for the second wafer image may be performed by the computer device. Image matching and subsequent failure pattern analysis may be performed by the computer device.

The first step of FIG. 3 illustrates a wafer image corresponding to a wafer bin map (WBM). The wafer image may show a two-dimensional image of a pass/failure determination result for each chip (i.e., die) in the wafer. In the wafer image, a first color (here, a first shade of gray) may represent a pass die (i.e., chip) and a second color (here, a second shade of gray) may represent a failure die (i.e., chip). The plurality of defective dies may form a predetermined pattern shape.

The second step of FIG. 3 illustrates a display of a plurality of keypoints extracted from the wafer image. The keypoint extraction algorithm may extract keypoints at the boundary between the pass and failure die and within/on the pattern caused by the failure die regions. The small white dots represent the keypoints. Reference may be made to the description of the above keypoints and their extraction process with reference to FIG. 1.

The third step of FIG. 3 illustrates an exemplary display of a plurality of descriptors generated from the plurality of keypoints. The plurality of descriptors may be generated by giving directional information to the plurality of keypoints. The arrows shown on the keypoints represent descriptors. Reference may be made to the description of the descriptors and processes of generating them with reference to FIG. 1.

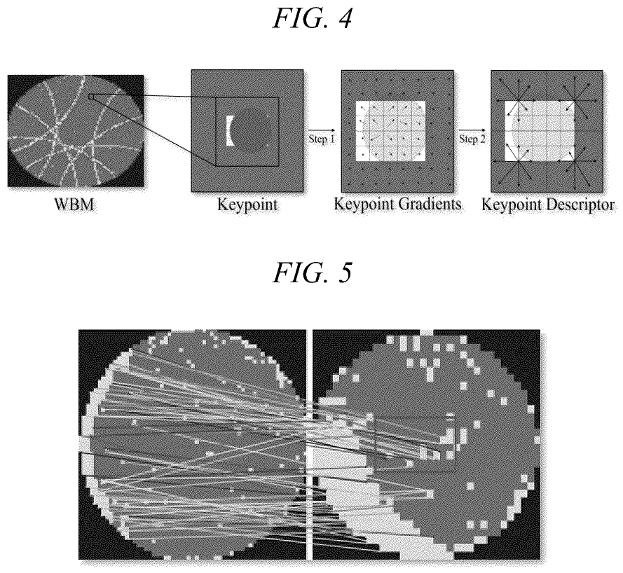

FIG. 4 is an exemplary diagram illustrating a process of keypoints extraction and descriptor generation that may be applied to a wafer failure pattern analysis process according to one embodiment of the present disclosure.

Referring to FIG. 4, keypoints may be extracted from the wafer image corresponding to the WBM, and descriptors for the keypoints may be generated. For example, the descriptor algorithm may generate an image patch to assign orientation information to the keypoints through a gradient operation. As a non-limiting example, a 16×16 patch may be generated around a keypoints to calculate a gradient by size and direction, which may be used to generate a histogram of the orientation of the keypoint, and the direction with the largest value in the histogram may be assigned as the orientation of the keypoint. This results in a 4×4 orientation histogram with eight orientations. However, these descriptor generation processes are only illustrative and may be varied.

FIG. 5 a process for evaluating similarity using Mscore and its challenges, according to an illustrative example.

Referring to FIG. 5, using the Mscore value calculated by image matching may lead to inaccurate results because the Mscore is also calculated for the outlier values and reflected in the similarity. In the wafer image on the right in FIG. 5, the rectangular area shown in the center represents an outlier region. The outlier region may appear in areas other than the failure pattern area.

In an embodiment of the present disclosure, in the absence of pre-processing, the image similarity may be numerically evaluated according to a first algorithm using a normalized score, which normalizes the matching score or normalizes the squared value of the matching score, to reduce the influence of outlier regions, which are regions other than the fault pattern region. The first algorithm may use a confidence score.

The matching score may be a Mscore. The plurality of Mscores may be normalized to a value between 0 and 1 to derive a normalized score. Alternatively, the plurality of Mscores², which is the respective squared values of the plurality of Mscores, may be normalized between 0 and 1 to derive a normalized score.

According to one embodiment, a plurality of confidence values may be derived by assigning different weights to the plurality of the matching scores (e.g., Mscores) based on a size range of the plurality of the normalized scores obtained for the plurality of features matched between the first and the second wafer images, and a confidence score may be derived by dividing the sum of the sum of the plurality of confidence values by the number of the plurality of features matched.

For example, the confidence score may be defined by the equations 1-1, 1-2, and 1-3 below.

$${N}_{i} = Normalization ( {Mscore}_{i} ) \qquad [ Equation 1 - 1 ]$$

$${confidence}_{i} = \{ \begin{matrix}1 \times {Mscore}_{i} & if {N}_{i} > 0.875 \\ 0.7 \times {Mscore}_{i} & if 0.575 \leq {N}_{i} \leq 0.875 \\ 0.4 \times {Mscore}_{i} & if 0.375 \leq {N}_{i} \leq 0.575 \\ 0.1 \times {Mscore}_{i} & Otherwise\end{matrix} \qquad [ Equation 1 - 2 ]$$

$$Confidence score = \frac{{\sum }_{i = 1}^{K} {confidence}_{i}}{{Keypoint}_{matched}} \qquad [ Equations 1 - 3 ]$$

As shown in Equation 1-1 above, each Mscore in the plurality of Mscores (i.e., Mscoreᵢ) obtained for the plurality of features matched between the first and the second wafer images may be normalized to obtain a plurality of normalized scores Nᵢ. The normalization may be a normalization between 0 and 1.

As shown in Equations 1-2 above, a plurality of confidence values may be derived by weighting (multiplying) the plurality of Mscoreᵢ differently according to a size range of the plurality of normalized scores Nᵢ. The plurality of confidence values is denoted by confidenceᵢ. Here, the number of bins and weight values based on the size of Nᵢ are exemplary and may be varied. The number of bins may be two or more, and the weight may be increased for larger bins of Nᵢ.

As shown in Equations 1-3 above, a confidence score may be derived by summing the plurality of confidence values confidence; and dividing the summed value by the number of a plurality of matched keypoints Keypoint_{matched}. Assuming that the total number of matched keypoints is K, the confidence score may be calculated for all keypoints (from the first to the Kth). The confidence score may result in a value of 1 or a prime number less than 1, and this score may correspond to a similarity number.

Meanwhile, here's a more detailed explanation of Mscore.

Mscore may be an indicator of the similarity between features. Mscoreᵢ may correspond to a dot product value between the ith descriptor of the source WBM image and the ith descriptor of the target WBM image. In one example, a nearest neighbor algorithm or an attention algorithm may be used to extract pairs of descriptors that are determined to be most similar between WBMs. The dot product between the descriptors may then be taken to compute a Mscore matrix of size M×N (M, N: the total number of keypoints extracted from the source WBM and target WBM, respectively). For example, the value at (1, 1) in the Mscore matrix may be the dot product between the descriptors of the 1st keypoint in the source WBM and the target WBM. The keypoints with the largest dot product values in the Mscore matrix may be matched with each other. However, a feature may not be matched if its dot product value, despite having the largest dot product value, does not exceed a user-defined threshold∈{0, 1}. Mscore; may be the dot product value between the descriptors of the ith keypoint matched between the two WBMs. In addition, the Mscore may have any of the characteristics of Mscores generally known in the art.

According to another embodiment, a plurality of confidence values normalized by the squared values of the plurality of matching scores (e.g., Mscore) obtained for the plurality of features matched between the first and the second wafer images may be derived, and the sum of the plurality of confidence values may be divided by the number of the matched plurality of features to derive a confidence score.

In this case, for example, the confidence score may be defined by Equations 2-1 and 2-2 below.

$${Confidence}_{i} = Normalization ( {Mscore}_{i}^{2} ) \qquad [ Equation 2 - 1 ]$$

$$Confidence score = \frac{{\sum }_{i = 1}^{K} {confidence}_{i}}{{Keypoint}_{matched}} \qquad [ Equation 2 - 2 ]$$

As shown in Equation 2-1, a plurality of confidence values may be derived by normalizing the plurality of Mscore squared values, Mscoreᵢ², obtained for the plurality of features matched between the first and second wafer images. The normalization may be a normalization between 0 and 1. The plurality of confidence values is denoted by confidenceᵢ. The plurality of confidence values may be referred to as a ‘normalized score’.

As shown in Equation 2-2 above, a confidence score may be derived by summing the plurality of confidence values confidence; and dividing the summed value by the number of a plurality of matched keypoints Keypoint_{matched}. Assuming that the total number of matched keypoints is K, the confidence score may be calculated for all keypoints (from the first to the Kth). The confidence score may result in a value of 1 or a number less than 1, which may correspond to a similarity number.

When utilizing a confidence score as defined in Equation 1-3 or Equation 2-2 above, the influence of outlier regions may be reduced and a similarity calculation may be possible that more accurately reflects the shape (appearance) of the failure patterns of the first and the second wafer images. Thus, the accuracy of the similarity evaluation may be improved. By normalization and weighting, the effect of reducing the influence of outliers and improving the accuracy of the evaluation may be obtained.

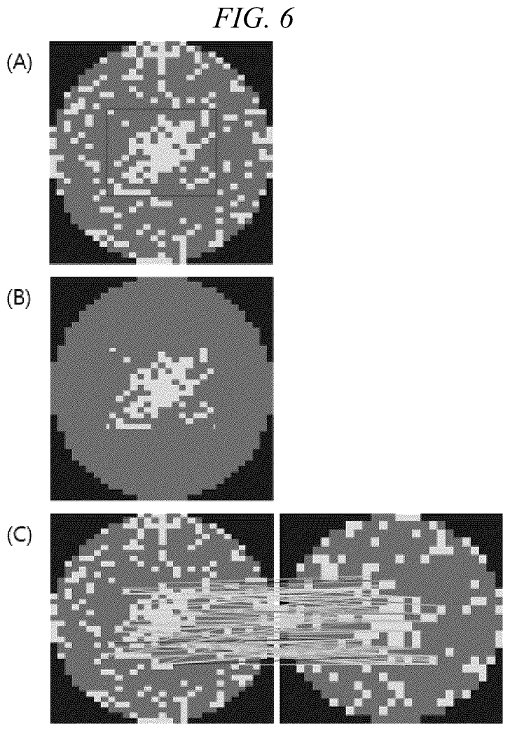

FIG. 6 illustrates an example of a pre-processing and applied image matching process that may be applied to a wafer failure pattern analysis process according to one embodiment of the present disclosure.

Referring to FIG. 6, pre-processing may be performed to set a region determined to be a failure pattern region in the first wafer image as a region of interest. (A) In the figure, the region shown as a dark rectangle may be the region of interest. (B) As shown in the drawing, regions other than the areas of interest may be set as areas of indifference or deleted. (C) illustrates image matching performed between two preprocessed wafer images. Image matching may be performed between a first region of interest in a first wafer image (as shown in (A) but not reproduced in (C)) and a second region of interest in a second wafer image. When preprocessing is performed, image matching may be performed only on areas of interest.

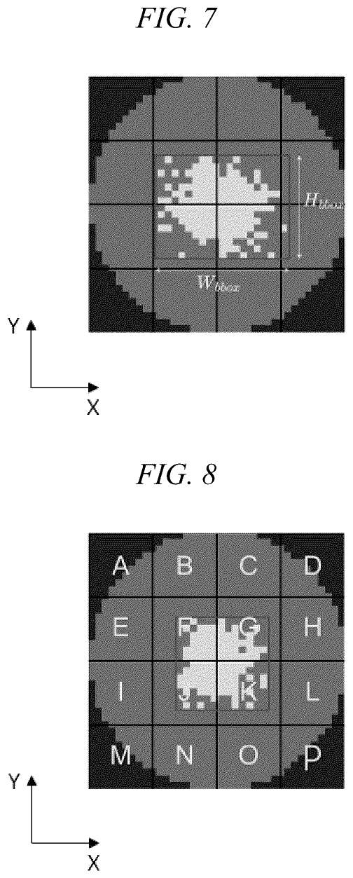

FIG. 7 illustrates an example of a process for deriving size information of a region of interest that may be applied to a wafer failure pattern analysis process according to one embodiment of the present disclosure.

Referring to FIG. 7, size information may be derived for an area of interest obtained from a wafer image. The rectangular area shown here may correspond to the areas of interest. The width (W_{bbox}) and height (H_{bbox}) of the area of interest may be measured to derive the width. The width (W_{bbox}) may be a horizontal length, and the height (H_{bbox}) may be a vertical length.

FIG. 8 illustrates an example of a process for deriving location information of a region of interest that may be applied to a wafer failure pattern analysis process according to one embodiment of the present disclosure.

Referring to FIG. 8, location information may be derived for a region of interest obtained from a wafer image. The rectangular region shown here may correspond to a region of interest. The wafer image may be divided into a plurality of pixel regions having a two-dimensional arrangement. The plurality of pixel regions may be arranged, for example, to form a plurality of rows and a plurality of columns in a horizontal direction (e.g., along an X-axis direction) and a vertical direction (e.g., along a Y-axis direction). The plurality of pixel regions may be arranged, for example, in a checkerboard structure. The plurality of pixel regions may have a constant size. Position information of the pixel region(s) corresponding to the region of interest may be derived. Thus, location information of the region of interest may be derived.

According to an embodiment of the present disclosure, when preprocessing is utilized, image similarity may be numerically evaluated according to a second algorithm reflecting information of a first region of interest obtained from a first wafer image and information of a second region of interest obtained from a second wafer image, thereby increasing the accuracy of the similarity calculation. The second algorithm may use a match of defect (MoD) score to calculate the similarity.

The second algorithm may evaluate the similarity between the first wafer image (source WBM) and the second wafer image (target WBM) using at least one of the size information and the location information of the first region of interest obtained through preprocessing and at least one of the size information and the location information of the second region of interest obtained through preprocessing. Using the second algorithm, the similarity calculation may take into account not only the shape (appearance) of the failure patterns in the two wafer images, but also the size and location of the failure patterns.

For example, the MoD score may be defined by Equations 3-1 through 3-4 below.

$$Size = {W}_{bbox} \times {H}_{bbox} \qquad [ Equation 3 - 1 ]$$

$${P}_{Size} = \{ \begin{matrix}\frac{{Size}_{target}}{{Size}_{source}} & if {Size}_{source} \geq {Size}_{target} \\ \frac{{Size}_{source}}{{Size}_{target}} & if {Size}_{source} < {Size}_{target} \\ 0 & Otherwise\end{matrix} \qquad [ Equation 3 - 2 ]$$

$${P}_{Location} = \frac{{Region}_{source ⋂ target}}{{Region}_{source}} \qquad [ Equation 3 - 3 ]$$

$$MoD score = {P}_{Size} \times {P}_{Location} \times Mscore \qquad [ Equation 3 - 4 ]$$

The second algorithm may include deriving a size of the first region of interest, deriving a size of the second region of interest, and comparing the sizes of the first and the second regions of interest to derive a first penalty value associated with the size of the region of interest. The equation 3-1 may be an expression for deriving the size of the region of interest.

The first penalty value may be defined by Equation 3-2. In Equation 3-2, the P_{Size} represents the first penalty value, the Size_{source} represents the size of the first region of interest, and the Size_{target} represents the size of the second region of interest. In the case where Size_{source}≥Size (target), Size target/Size_{source} may be set as the first penalty value P_{Size}, in the case where Size (source)<Size_{target}, Size source/Size_{target} may be set as the first penalty value (P_{Size}), and in the other case, 0 may be set as the first penalty value (P_{Size}). In such other cases, at least one of Size source and Size_{target} may be unmeasured. According to another embodiment, in Equation 3-2 above, if Size_{source} and Size_{target} are equal, the second item may be moved instead of the first item. That is, if Size_{source}>Size_{target}, then Size_{target}/Size_{source} may be set as the first penalty value (P_{Size}), if Size_{source}≤Size_{target}, then Size_{source}/Size_{target} may be set as the first penalty value (P_{Size}), and otherwise, 0 may be set as the first penalty value (P_{Size}).

The second algorithm may include deriving location information of the first region of interest, deriving location information of the second region of interest, and comparing the location information of the first region of interest to the location information of the second region of interest to derive a second penalty value associated with the locations of the regions of interest. The step of deriving the location information of the regions of interest may be as described in FIG. 8.

The second penalty value may be defined by Equation 3-3. In Equation 3-3, the P_{Location} indicates the second penalty value, the Region_{source} indicates the number of pixel regions corresponding to the first region of interest, and the Region_{source∩target} indicates the number of pixel regions where the first and the second regions of interest exist together. The Region_{source∩target} may be a count of pixel regions corresponding to regions where the first and the second regions of interest overlap. The second penalty value P_{Location} may increase as the number of pixel regions in which the first and second regions of interest co-exist increases.

According to one embodiment, the second algorithm may comprise the step of deriving a MoD score by multiplying the first penalty value and the second penalty value by a region of interest matching score derived for the plurality of features matched between the first and the second regions of interest by the first penalty value. Here, the step of deriving the MoD score may be defined as in Equations 3-4 above. In Equations 3-4, the item labeled Mscore represents a region of interest matching score derived for the plurality of features matched between the first and the second regions of interest. The region of interest matching score may be, for example, an average of a plurality of matching scores derived for the plurality of features matched between the first and the second regions of interest. The region of interest matching score may be expressed, for example, as Mscore_{(R)}. The MoD score may be 1 or a fractional value less than 1, and the score may correspond to a similarity number.

The MoD score may reflect the size and location information of the first and the second regions of interest. The more similar the sizes of the first and the second regions of interest are, and the more similar the location information of the first and the second regions of interest is, the higher the MoD score may be. Using the second algorithm, the similarity calculation may take into account not only the shape (appearance) of the failure patterns in the two wafer images, but also the size and location of the failure patterns.

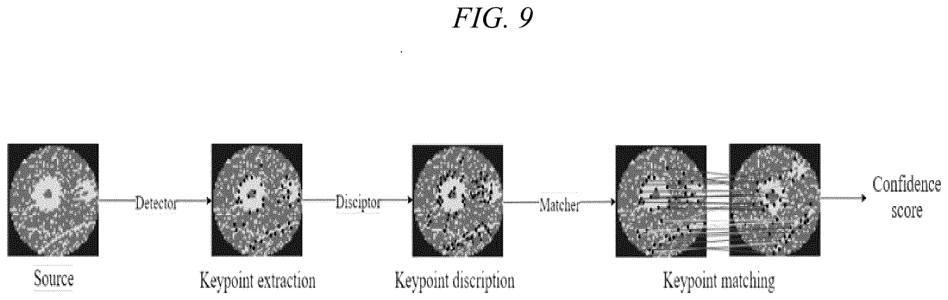

FIG. 9 is a visualized flow diagram illustrating a similarity-based wafer failure pattern analysis process using image matching, according to one embodiment of the present disclosure. The wafer failure pattern analysis process may be a similarity-based wafer failure pattern discovery process.

Referring to FIG. 9, a process of similarity-based wafer failure pattern analysis using image matching according to an embodiment may be a first process of evaluating image similarity of the first and the second wafer images in the first manner described above, without utilizing preprocessing. The first process may utilize a confidence score.

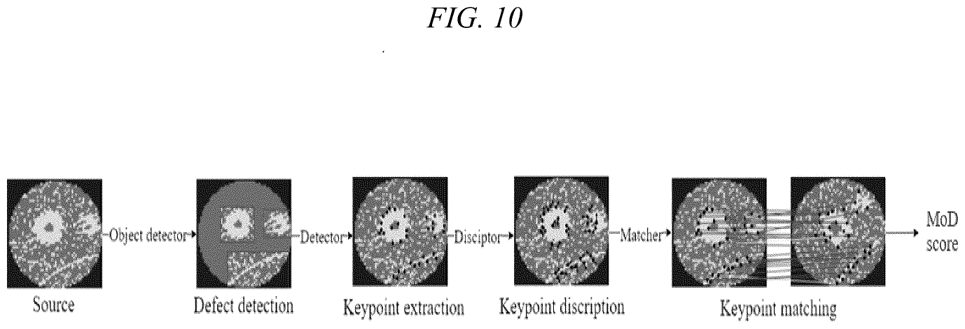

FIG. 10 is a visualized flow diagram illustrating an exemplary similarity-based wafer failure pattern analysis process using image matching, according to another embodiment of the present disclosure. The wafer failure pattern analysis process may be a similarity-based wafer failure pattern discovery process.

Referring to FIG. 10, a process of similarity-based wafer failure pattern analysis using image matching, according to an embodiment, may be a second process of evaluating image similarity of the first and the second wafer images in a second manner as described above, using preprocessing. The second process may use a MoD score.

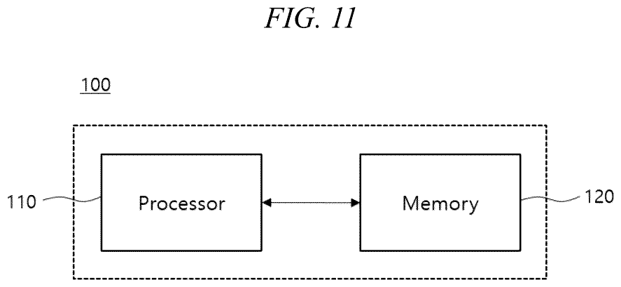

FIG. 11 is a block diagram illustrating a similarity-based wafer failure pattern analysis apparatus 100 using image matching, according to one embodiment of the present disclosure.

Referring to FIG. 11, the wafer failure pattern analysis apparatus 100 according to an embodiment of the present disclosure may be a computer device (electronic device). The wafer failure pattern analysis apparatus 100 may include a processor 110 and a memory 120. The memory 120 comprises a non-transient computer-readable medium. The processor 110 may be a processing unit. The processor 110 may comprise at least one processor. The memory 120 may store one or more instructions. By executing the one or more instructions, the processor 110 optionally performs pre-processing to establish a region of interest determined to be a failure pattern region in a first wafer image corresponding to a wafer bin map (WBM), and obtaining a plurality of keypoints and a plurality of descriptors associated therewith from the first wafer image, performing an image matching between the first wafer image and the second wafer image corresponding to the WBM, wherein the second wafer image has a plurality of keypoints obtained from the first wafer image and a plurality of descriptors associated therewith, optionally performing the image matching in a keypoint matching manner based on a comparison of the descriptors, and numerically evaluating an image similarity between the first and the second wafer images. The processor 110 may numerically evaluate the image similarity according to a first algorithm using a normalized score that normalizes or squares a matching score representing the similarity between the keypoints, if the preprocessing has not been performed, or according to a second algorithm that utilizes information of a first region of interest obtained from the first wafer image and information of a second region of interest obtained from the second wafer image, if the preprocessing has been performed.

The processor 110, by executing the one or more instructions: performing preprocessing to establish a region of interest determined to be a failure pattern region in the first wafer image corresponding to the WBM; acquiring a plurality of keypoints and a plurality of descriptors associated therewith in the first wafer image; and performing image matching between the first wafer image and the second wafer image corresponding to the WBM, wherein the image matching is performed in a keypoint matching process based on descriptor comparison, wherein the second wafer image has a plurality of keypoints obtained from the first wafer image and a plurality of descriptors associated therewith, and wherein the processor 110 may be configured to perform the image matching in a keypoint matching manner based on descriptor comparison, and wherein the processor 110 numerically evaluates the image similarity between the first and the second wafer images. The processor 110 may numerically evaluate the image similarity in a manner that reflects information of a first region of interest obtained from the first wafer image and information of a second region of interest obtained from the second wafer image.

In addition, all of the features and configurations of the embodiments previously described with reference to FIGS. 1 through 4 and FIGS. 6 through 10 may also be applied to the wafer failure pattern analysis apparatus 100 of FIG. 11. Further, the wafer failure pattern analysis apparatus 100 may further include an input/output interface, an input/output device, a network communication interface, and the like.

Experiments were conducted on the WM-811K and MixedWM38 datasets by applying the analysis (search) algorithms according to embodiments. The WM-811K dataset contains 811457 WBMs with 8 labeled data types (Center, Donut, Loc, Edge-Loc, Edge-Ring, Scratch, Near-full, and Random). The MixedWM38 dataset has about 38000 images and a total of 38 defect patterns, including the 8 classes of WM-811K.

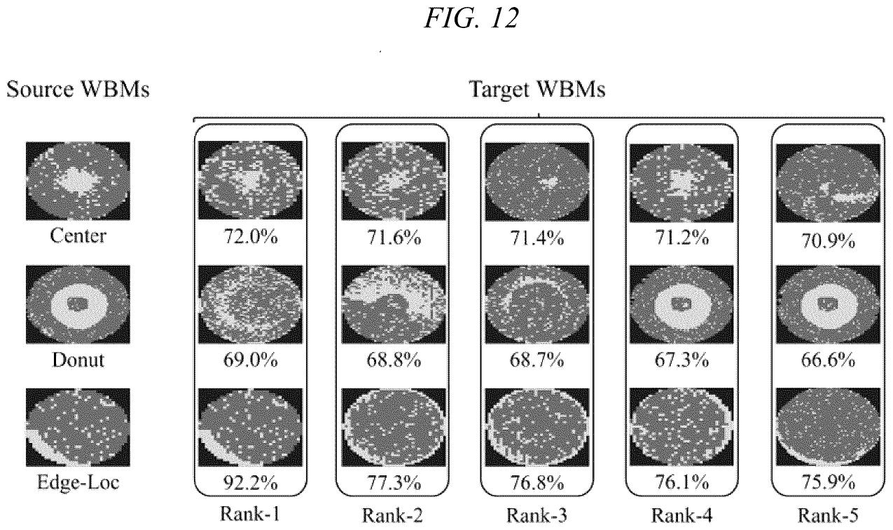

FIG. 12 illustrates the results of performing a failure pattern analysis using a wafer failure pattern analysis process according to an embodiment of the present disclosure.

Referring to FIG. 12, this embodiment shows the results of evaluating image similarity according to the first algorithm above without utilizing preprocessing. In addition, this embodiment is for the case where the source WBM image has a single failure pattern. The number (%) listed under each target WBM image indicates the similarity to the corresponding source WBM image.

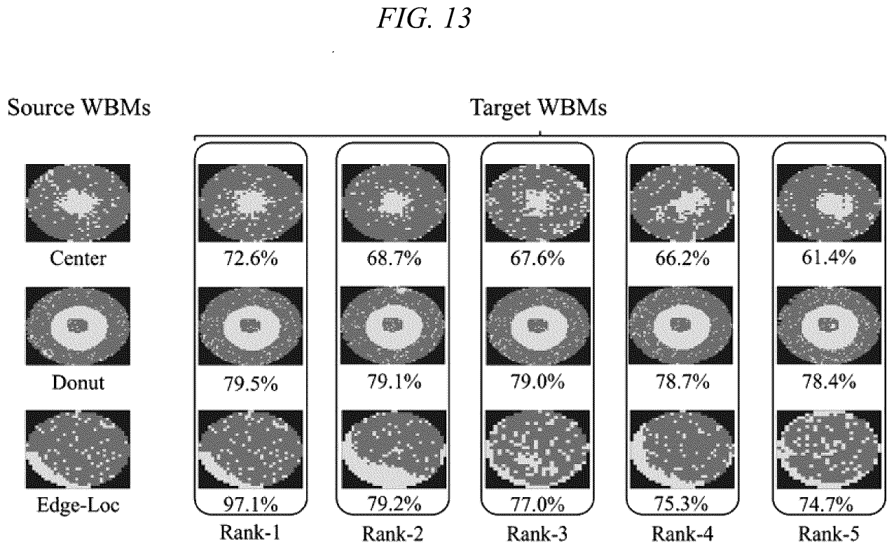

FIG. 13 is an exemplary diagram illustrating the results of performing a failure pattern analysis using a wafer failure pattern analysis process according to an embodiment of the present disclosure.

Referring to FIG. 13, this embodiment shows the result of applying the preprocessing and evaluating the image similarity according to the second algorithm above. In addition, this embodiment is for the case where the source WBM image has a single failure pattern. The number (%) listed under each target WBM image indicates the similarity to the corresponding source WBM image.

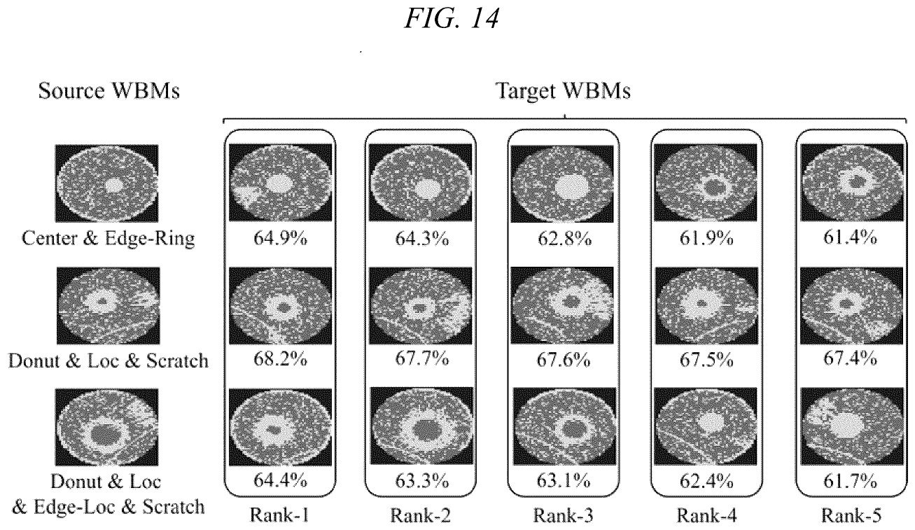

FIG. 14 is an exemplary diagram illustrating the results of performing a failure pattern analysis using a wafer failure pattern analysis process according to an embodiment of the present disclosure.

Referring to FIG. 14, this embodiment shows the results of evaluating image similarity according to the first algorithm without utilizing preprocessing. In addition, this embodiment is for a case where the source WBM image has a composite failure pattern. The number (%) listed under each target WBM image indicates the similarity to the corresponding source WBM image.

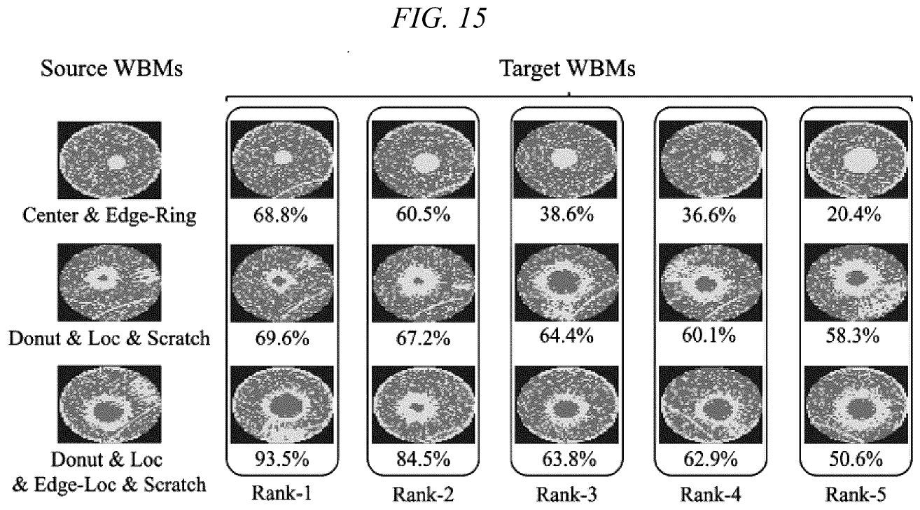

FIG. 15 is an exemplary diagram illustrating the results of performing a failure pattern analysis using a wafer failure pattern analysis process according to an embodiment of the present disclosure.

Referring to FIG. 15, this embodiment shows the results of applying the preprocessing and evaluating the image similarity according to the second algorithm above. In addition, this embodiment is for a case where the source WBM image has a composite failure pattern. The number (%) listed under each target WBM image indicates the similarity to the corresponding source WBM image.

According to the embodiments of the present disclosure described above, a similarity-based wafer failure pattern analysis process and apparatus using image matching that may effectively analyze wafer failure patterns may be implemented by numerically evaluating image similarity between a source wafer image, which is a target for failure pattern analysis, and a target wafer image(s) to be compared. In addition, according to embodiments of the present disclosure, by using a process of numerically evaluating/analyzing image similarity according to a predetermined process rather than a conventional classification process, a similarity-based wafer failure pattern analysis process and apparatus using image matching that does not require labeled data (i.e., labeled WBM data) for learning and is useful for efficiently analyzing causes of single/complex failure patterns may be implemented. In addition, embodiments of the present disclosure enable the implementation of a similarity-based wafer failure pattern analysis process and apparatus using image matching that enables efficient analysis because the target wafer image may be searched for any desired information such as the shape (appearance), location, or size of the failure pattern. Furthermore, according to embodiments of the present disclosure, a similarity-based wafer failure pattern analysis process and apparatus using image matching may be implemented that may increase the accuracy and efficiency of wafer failure pattern analysis and failure cause analysis. By using the similarity-based wafer failure pattern analysis process and apparatus using image matching according to embodiments of the present disclosure, the cause of a problem in a semiconductor process may be identified more quickly and accurately, process optimization may be performed, and the yield of a semiconductor process may be increased.

This description discloses preferred embodiments of the present invention, and although certain terms are used, they are used in a general sense only to facilitate the description and understanding of the invention and are not intended to limit the scope of the invention. In addition to the embodiments disclosed herein, other modifications based on the technical ideas of the present invention will be apparent to those of ordinary skill in the art to which the present invention belongs. One of ordinary skill in the art will recognize that the method and apparatus for similarity-based wafer failure pattern analysis using image matching according to the embodiments described with reference to FIGS. 1 to 4 and FIGS. 6 to 15 may be subject to various substitutions, changes, and modifications without departing from the technical ideas of the present invention. Therefore, the scope of the invention is not to be defined by the embodiments described, but by the technical ideas recited in the patent claims.

What is claimed is:

1. A method of analyzing similarity-based wafer failure patterns, the method comprising:
obtaining a plurality of keypoints and a plurality of descriptors associated therewith from a first wafer image;
performing image matching between the first wafer image and a second wafer image corresponding to a Wafer Bin Map (WBM), wherein there are a plurality of keypoints obtained from the second wafer image and a plurality of descriptors associated therewith, and wherein the image matching is performed in a keypoint matching process based on descriptor comparison; and
numerically evaluating image similarity between the first and the second wafer images.

2. The method of claim 1, wherein numerically evaluating image similarity between the first and the second wafer images comprises:
numerically evaluating the image similarity according to a first algorithm using a normalized score that normalizes a matching score or normalizes a square of the matching score, the matching score being representative of the similarity between keypoints.

3. The method of claim 2, wherein the first algorithm comprises,
deriving a plurality of confidence values by assigning different weights to the plurality of the matching scores based on a range of magnitudes of the plurality of the normalized scores obtained for the plurality of features matched between the first and the second wafer images; and
deriving a confidence score by dividing a sum of the plurality of confidence values by a number of the matched plurality of keypoints.

4. The method of claim 2, wherein the first algorithm comprises,
deriving a plurality of confidence values normalized by the squared values of the plurality of the matching scores obtained for the plurality of features matched between the first and the second wafer images; and
deriving a confidence score by dividing a sum of the plurality of confidence values by a number of the matched plurality of keypoints.

5. The method of claim 1, further comprising:
performing pre-processing to establish first and second regions of interest that are determined to be failure pattern regions in the first wafer image corresponding to the WBM,
wherein numerically evaluating image similarity between the first and the second wafer images comprises numerically evaluating the image similarity according to a second algorithm that reflects information of a first region of interest obtained from the first wafer image and information of a second region of interest obtained from the second wafer image.

6. The method of claim 5, wherein the second algorithm utilizes at least one of size and location information of the first region of interest and at least one of size and location information of the second region of interest.

7. The method of claim 5, wherein the second algorithm comprises:
deriving the size of the first region of interest;
deriving the size of the second region of interest; and
comparing the sizes of the first and the second regions of interest to derive a first penalty value associated with the size of the region of interest.

8. The method of claim 7, wherein the first penalty value is defined by the following mathematical expression:
$${P}_{Size} = \{ \begin{matrix}\frac{{Size}_{target}}{{Size}_{source}} & if {Size}_{source} \geq {Size}_{target} \\ \frac{{Size}_{source}}{{Size}_{target}} & if {Size}_{source} < {Size}_{target} \\ 0 & Otherwise\end{matrix} \qquad [ math expression ]$$
wherein the P_{Size} represents the first penalty value, the Size_{source} represents the size of the first region of interest, and the Size_{target} represents the size of the second region of interest.

9. The method of claim 5, wherein the second algorithm comprises:
deriving the location information of the first region of interest;
deriving location information of the second region of interest; and
comparing location information of the first and the second regions of interest to derive a second penalty value associated with the location of the regions of interest.

10. The method of claim 9, wherein the second penalty value is a similarity-based wafer failure pattern analysis method defined by the following mathematical expression:
$${P}_{Location} = \frac{{Region}_{source ⋂ target}}{{Region}_{source}} \qquad [ math expression ]$$
wherein the P_{Location} represents the second penalty value, the Region_{source} represents the number of pixel regions corresponding to the first region of interest, and the Region_{source∩target} represents the number of pixel regions in which the first and the second regions of interest exist together.

11. The method of claim 5, wherein the second algorithm comprises:
deriving the size of the first region of interest;
deriving the size of the second region of interest;
comparing the sizes of the first and the second regions of interest to derive a first penalty value associated with the size of the region of interest;
deriving the location information of the first region of interest;
deriving the location information of the second region of interest;
comparing the location information of the first and the second regions of interest to derive a second penalty value associated with the location of the region of interest; and
deriving a region of interest match score derived for a plurality of features matched between the first and second regions of interest by multiplying the first penalty value and the second penalty value to derive a match of defect (MoD) score.

12. The method of claim 1, wherein the second wafer image is an image included in a wafer image database comprising one or more wafer images corresponding to the WBM.

13. The method of claim 1, wherein the second wafer image is an unprocessed image.

14. The method of claim 1, wherein the second wafer image is a preprocessed image.

15. The method of claim 1, wherein the image matching is performed using a graph neural network (GNN) model.

16. The method of claim 1, wherein the image matching is performed using a matching algorithm based on graph attention networks (GATs).

17. A method of analyzing similarity-based wafer failure patterns, the method comprising:
performing pre-processing to establish regions of interest that are determined to be failure pattern regions in the first wafer image corresponding to the wafer bin map (WBM);
obtaining a plurality of keypoints and a plurality of descriptors associated therewith from the first wafer image;
performing image matching between the first wafer image and a second wafer image corresponding to the WBM, wherein there are a plurality of keypoints obtained from the second wafer image and a plurality of descriptors associated therewith, and wherein the image matching is performed in a keypoint matching method based on descriptor comparison; and
numerically evaluating an image similarity between the first and the second wafer images, using information of a first region of interest obtained from the first wafer image and information of a second region of interest obtained from the second wafer image.

18. An apparatus for analyzing similarity-based wafer failure pattern, comprising a processor and a memory comprising non-transient computer readable-media, the non-transient computer readable-media storing one or more instructions, and the processor executing the one or more instructions to perform steps comprising:
obtaining a plurality of keypoints and a plurality of descriptors associated therewith from the first wafer image,
performing image matching between the first wafer image and a second wafer image corresponding to a Wafer Bin Map (WBM), wherein there are a plurality of keypoints obtained from the second wafer image and a plurality of descriptors associated therewith, and wherein the image matching is performed in a keypoint matching method based on descriptor comparison; and
numerically evaluating image similarity between the first and the second wafer images.

19. The apparatus of claim 18, wherein numerically evaluating image similarity between the first and the second wafer images comprises:
numerically evaluating the image similarity according to a first algorithm using a normalized score that normalizes a matching score or that normalizes a square of the matching score, the matching score being representative of the similarity between the keypoints.

20. The apparatus of claim 18,
wherein the steps further comprise performing pre-processing to establish regions of interest that are determined to be failure pattern regions in a first wafer image corresponding to the WBM, and
wherein numerically evaluating image similarity between the first and the second wafer images comprises numerically evaluating the image similarity according to a second algorithm reflecting information of a first region of interest obtained from the first wafer image and information of a second region of interest obtained from the second wafer image.
